(19) United States
(12) Patent Application Publication
(10) Pub. No.: US 2005/0156359 A1
(43) Pub. Date: Jul. 21, 2005

(54) Container wall post-forming

(76) Inventor: Adolfo Serrano, San Jose (CR)

Correspondence Address: COLGATE-PALMOLIVE COMPANY, 909 RIVER ROAD, PISCATAWAY, NJ, 08855, US

(21) Appl. No.: 10/503,742

(22) PCT Filed: Jan. 30, 2003
(86) PCT No.: PCT/US03/02812

Related U.S. Application Data
(60) Provisional application No. 60/354,182, filed on Feb. 4, 2002.

(51) Int. Cl. B29C 47/06

(52) U.S. Cl. 264/514; 264/173.12; 264/173.14; 264/173.15; 264/210.1; 264/294; 264/320

(57) ABSTRACT

Tube containers that have a barrier structure can be altered in shape by post-forming techniques. This post-forming comprises placing a formed and heated tube on a mandrel and having a surrounding mold having the final desired shape of the tube. The inner wall then is pressurized through the mandrel with an optional use of a vacuum on the mold. The tube walls are altered in shape to a degree that will not be deleterious to the barrier properties of the tube wall.

### FIELD OF THE INVENTION

This invention relates to a finished container where the shape of at least part of the structure of the walls is changed. More particularly, this invention relates to a tube container where the shape of the tube container is changed after the formation of the tube.

### BACKGROUND OF THE INVENTION

In most instances the container is given its final shape at the time that it is manufactured. However, in some instances the container shape is modified after the container is made. This is to provide the container with some utilitarian feature or to provide a decoration. It has been found that a post forming technique is very useful for adding features or decoration to tube containers.

Japanese Patent Publication 56-20970 discloses a technique for modifying the shape of tube containers by means of placing the tube on a heated mandrel and blowing the tube wall to the shape of a surround mold. This modifies the tube wall. The heated mandrel is removed, the mold opened and the tube with an altered surface removed. U.S. Pat. No. 5,756,038 discloses a modification of this process where the mandrel has recesses and a vacuum is shown on the mandrel and/or is blown from the surrounding mold. The tube wall takes the shape of the mandrel recesses. The tube then is stripped from the mandrel recesses. These are interesting processes for making post-formed tubes. However, neither process takes into account tube walls that have a barrier layer. Such a barrier layer is part of a laminate or injection blowmolded tube. In situations where the barrier layer is for organic substances such as flavors or fragrances, it will be a metal layer, such as an aluminum layer or an organic layer, such as an ethylene vinylalcohol (EVOH) layer. In the alteration of the shape of a tube wall it is important that the barrier layer of the tube wall not be breached.

### BRIEF SUMMARY OF THE INVENTION

The invention is directed to the post-forming of containers, such as tube containers, where the container structure contains a barrier layer for moisture and/or organics. Organic barriers are usually directed to preclude the passing of flavors and fragrances through a container wall. These barriers are foils that are a part of a multilayer container wall and can be either organic or inorganic foils, such as aluminum or ethylene vinylalcohol foils. However, in the post-forming this barrier foil layer cannot be breached. This barrier foil layer must remain continuous, and continuous is a sufficiently thick layer to be an effective barrier after any post-forming. The metal or metal alloy of any inorganic barrier must have a sufficient ductility that the metal can spread and thin without any breaches. Likewise, for an organic barrier it must be able to thin, yet retain a sufficient thickness to provide an effective barrier. For a metal foil barrier layer the metal foils can initially be about 7 microns to about 50 microns, and preferably about 10 microns to 25 microns. This can be stretched about 1% to about 25%. More highly ductile materials can be subject to a greater degree of stretching. For an organic foil it can initially be about 5 microns to about 50 microns, and preferably about 10 microns to about 25 microns, and can be stretched about 1% to about 100% and retain effective barrier properties.

### BRIEF DESCRIPTION OF THE DRAWINGS

FIG. 1 is a cross-section of a typical container wall having a metal foil layer.

FIG. 2 is a cross-section of a typical container wall having an organic foil layer.

### DETAILED DESCRIPTION OF THE INVENTION

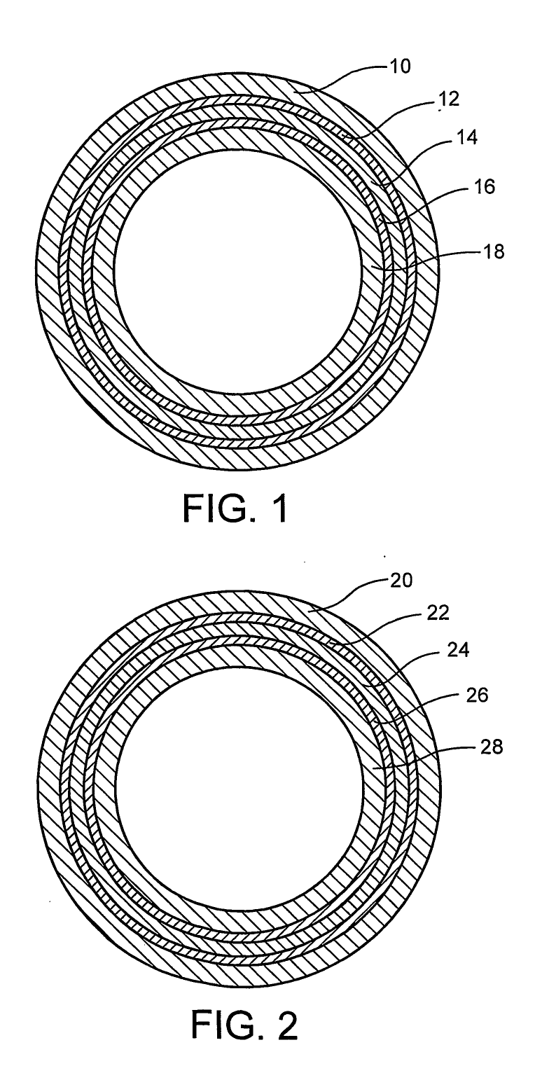

The post-forming of containers while maintaining the barrier properties of the container walls will now be described in more detail. FIGS. 1 and 2 describe the wall of typical containers having barrier walls. These container walls are formed from a laminate material or are formed by extrusion blowmolding. If the wall contains a metal foil it will be formed from a laminate material.

Although the present invention is applicable to any container, it is particularly applicable to tube containers.

FIG. 1 shows a foil laminate wall of a tube container. The foil is comprised of an outer polyethylene layer, an adhesive layer, an aluminum foil layer, an adhesive layer and an inner polyethylene layer. The outer polyethylene layer will have a thickness of about 50 microns to about 250 microns, the inner aluminum foil layer a thickness of about 7 microns to about 50 microns, and the inner polyethylene layer a thickness of about 50 microns to about 250 microns. The adhesive layers are any suitable adhesive such as ethyl acrylate copolymers, maleic anhydride modified copolymers and terpolymers, acrylic acid modified polyolefins, and ethyl methyl acrylate copolymers. The adhesives will have a thickness of about 0.25 microns to about 10 microns. The ductility of the aluminum or aluminum alloy or other metal will be about 1% to 25% and preferably about 8% to 15%. This material can be stretched about 1% to about 25% without any breach of the aluminum foil layer.

FIG. 2 shows a typical container wall comprising an organic barrier layer. This organic barrier layer can be any of ethylene, vinylalcohol copolymers, polyamides, polyesters, PVDC, ClCF₃ (Aclar)®, Barex®, and nano composites and liquid crystal polymers and blends. There will be an exterior layer of polyolefin, an adhesive layer, the organic film barrier layer, and an inner polyethylene layer. The adhesive will be any suitable adhesive such as any of the above described adhesives. The outer polyolefin layer will have a thickness of about 50 microns to about 250 microns, and preferably about 75 microns to about 200 microns. The organic barrier layer will be of a thickness of about 5 microns to about 50 microns, and preferably about 15 microns to about 30 microns. The inner polyolefin layer will have a thickness of about 50 microns to about 250 microns, and preferably about 75 microns to about 200 microns. These container walls can be from a laminate or can be formed by extrusion blowmolding. The container wall having this structure can be stretched about 1% to about 100%. This is greater than when a metal foil is used as the barrier layer.

It was found that a laminate structure having a 25 micron ethylene vinyl alcohol barrier had equivalent to slightly improved barrier properties after stretching. It is theorized that the stretching induces orientation into the ethylene vinyl alcohol film whereby although thinned, it maintains or has slightly improved barrier properties with regard to flavors. This was not expected with the opinion being that stretching the film would have a deleterious effect.

The container wall stretching by post-forming techniques will put decorative and/or functional features onto the container wall. The techniques that can be used are those described in Japanese Patent Publication 56-20970 and U.S. Pat. No. 5,756,038 which are incorporated herein by reference. Further, in a modification of the technique in Japanese Patent Publication 56-20970, the container wall can be modified solely by a vacuum drawn on the mold sections or by a vacuum drawn on the mold sections and a pressure blowing from the mandrel to provide a positive pressure in the mold. In any of these techniques the container wall will be formed to have a stiffening shape. A third technique involves the mechanical stamping of the tube wall. This uses a mold with an expandable mandrel. The container is heated and is put into the mold and the expandable mandrel into the container. Upon actuation the expandable mandrel then pushes the walls of the container against the inner surface of the mold, forming the surface features desired on the exterior surface of the container (see attached drawing of mandrel).

The containers that are suitable for post-forming are those that will contain a toothpaste, a lotion, a gel product, food products, lubricants, medicants and the like. The structures that can be post-formed onto tubes include grips and various decorations. For instance, a figure of a person or animal that is pictured on a tube also can be raised to form a more decorative tube container.

1. A method of post forming a tube container to a different shape and maintaining the barrier properties of said tube container comprising providing a multilayer laminate tube having at least one barrier layer and at least one thermoplastic layer on each side of said barrier layer, said barrier layer elongatable up to about 125% of its length without whereby said barrier layer maintains at least about 90% of its barrier properties.

2. A method as in claim 1 wherein said barrier layer is a metal layer.

3. A method as in claim 2 wherein said metal is aluminum.

4. A method as in claim 2 wherein said metal is an aluminum alloy.

5. A method as in claim 2 wherein said metal is a metal film having a thickness of about 7 microns to about 50 microns.

6. A method as in claim 2 wherein each thermoplastic layer is a polyolefin.

7. A method as in claim 6 wherein said polyolefin is selected from the group consisting of polyethylenes and polypropylenes.

8. A method as in claim 1 wherein said barrier layer is an organic barrier layer.

9. A method as in claim 8 wherein said organic barrier layer is a thermoplastic.

10. A method as in claim 9 wherein said thermoplastic is selected from the group consisting of polyamides, polyesters, vinyl alcohol polymers and copolymers, vinyl acetate polymers, vinyl chloride polymers and copolymers, vinylidene chloride polymers and copolymers, and liquid crystal polymers.

11. A method as in claim 8 wherein said organic barrier layer has a thickness of about 5 microns to about 50 microns.
